(19) United States
(12) Patent Application Publication
(10) Pub. No.: US 2013/0147661 A1
(43) Pub. Date: Jun. 13, 2013

(54) SYSTEM AND METHOD FOR OPTICAL LANDMARK IDENTIFICATION FOR GPS ERROR CORRECTION

(71) Applicants: Paul D. Kangas, Raleigh, NC (US); Robert T. Noble, Raleigh, NC (US); Jeff D. Thomas, Raleigh, NC (US)

(72) Inventors: Paul D. Kangas, Raleigh, NC (US); Robert T. Noble, Raleigh, NC (US); Jeff D. Thomas, Raleigh, NC (US)

(73) Assignee: INTERNATIONAL BUSINESS MACHINES CORPORATION, Armonk, NY (US)

(21) Appl. No.: 13/313,648

(22) Filed: Dec. 7, 2011

(51) Int. Cl. G01S 19/41

(52) U.S. Cl. 342/357.24; 342/357.23

(57) ABSTRACT

A system, method, and program product for determining an approximate position of a global positioning system (GPS) receiver of a global positioning receiver connected to a computer. The computer compares obtained image data of landmarks with a database of known landmarks to determine an approximate position of the GPS receiver at a specified time. The computer converts and transmits an error signal.

### FIELD OF THE INVENTION

The present invention relates generally to global positioning systems (GPS) and more specifically to error correction of GPS.

### BACKGROUND OF THE INVENTION

GPS receivers obtain a Longitude/Latitude position via time-distance triangulation with the collection of GPS satellites orbiting the Earth. As the line-of-site angles of the satellites to the GPS receiver continuously change over time, the position error of the location reported by the GPS receiver improves or declines. Typically, currently the best guaranteed position of a purely GPS receiver is not accurate enough for most desired functions. To compensate for the error involved in GPS, many systems utilize Differential GPS (DGPS). DGPS uses ground based towers that transmit an error signal to DGPS capable GPS receivers. DGPS requires an additional signal beacon receiver for the GPS receiver to receive the signal. Additionally, similar to DGPS, Wide Area Augmentation Systems (WAAS) enhancement to GPS improves accuracy by using ground stations to transmit error signals back to certain satellites. Known DGPS and WAAS method may be costly to operate because of the costs associated in the upkeep of satellites and additional equipment used in the GPS receivers.

An object of the present invention is to improve accuracy beyond the WASS accuracy by virtue of accurate database mappings of known street signs, highway center lines, and other landmarks along streets and highways where cars are known to operate.

### SUMMARY

Aspects of the present invention disclose a method, computer system, and computer program product for determining an approximate position of a global positioning system (GPS) receiver of a global positioning receiver connected to a computer.

A system, method and program product for determining an approximate position of a global positioning system receiver connected to a computer. The computer obtains image data surrounding the GPS receiver through a camera associated with the GPS receiver and operably coupled to the computer. The computer applies a time stamp to the obtained image data. The computer initiates a latency timer. The computer processes the obtained image data to determine if one or more artifacts are detected. The computer receives positioning signals from one or more satellites through the GPS receiver. The computer processes the positioning signals to produce an estimated position of the GPS receiver. The computer compares the obtained image data of the landmarks with a database of known landmarks situated near the estimated position of the GPS receiver to determine positions of the one or more known landmarks surrounding the estimated position of the GPS receiver. The computer determines an approximate position of the GPS receiver at a specified time correlated from applied time stamp of obtained image data that is more precise than the estimated position, based on determined positions of the one or more known landmarks relative to the GPS receiver and known locations of the plurality of the known landmarks.

### BRIEF DESCRIPTION OF THE SEVERAL VIEWS OF THE DRAWINGS

FIG. 1 depicts a system for determining an approximate position of a global positioning system (GPS) receiver of a global positioning receiver according to an embodiment of the present invention.

FIG. 2 depicts a system for determining an approximate position of a global positioning system (GPS) receiver of a global positioning receiver according to another embodiment of the present invention.

FIG. 3 depicts an example of how a GPS receiver may be associated with a vehicle.

FIG. 4 is a flow chart illustrating the steps of a program installed in a computer of FIG. 1 for determining if artifacts are detected in obtained image data.

FIG. 5 is a flow chart illustrating the steps of a program installed in the computer of FIG. 1 for determining if artifacts are landmarks in known positions.

FIG. 6 is a flow chart illustrating the steps of a program installed in the computer of FIG. 1 for determining an approximate position of the GPS receiver at a specified time that is more precise than a position estimated from standard GPS signals.

FIG. 7 is a block diagram of components of computers of FIGS. 1 and 2 (such as a microprocessor or server computer) depicted in accordance with an illustrative embodiment.

### DETAILED DESCRIPTION

The present invention will now be described in detail with reference to the figures.

Although the examples may depict the system used in conjunction with a vehicle, this should not limit the use of the system. Other examples of the system may be used in conjunction with known uses of a GPS receiver.

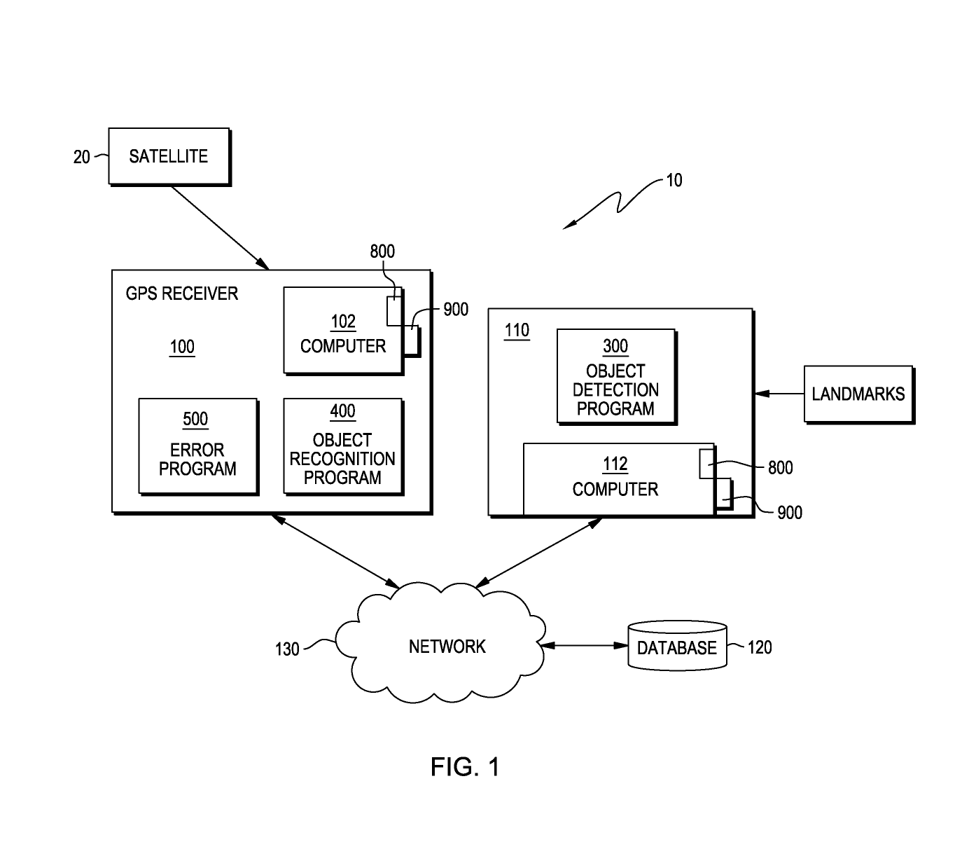

FIG. 1 illustrates as GPS system generally designated 10 according to one embodiment of the present invention. In this embodiment, the system 10 includes a GPS receiver 100 that receives positioning signals from one or more satellites 20. The GPS receiver 100 is connected with a camera 110 and a database 120 of known landmarks through a network 130. The camera 110 includes a computer 112 that includes an object detection program 300 that determines if artifacts are detected in obtained image data. A computer 102 connected through the network 130 includes an object recognition program 400 that determines if artifacts are landmarks in known positions. The computer 102 includes an error program 500, which determines an approximate position of the GPS receiver 100 at a specified time that is more precise than a position estimated from standard GPS signals.

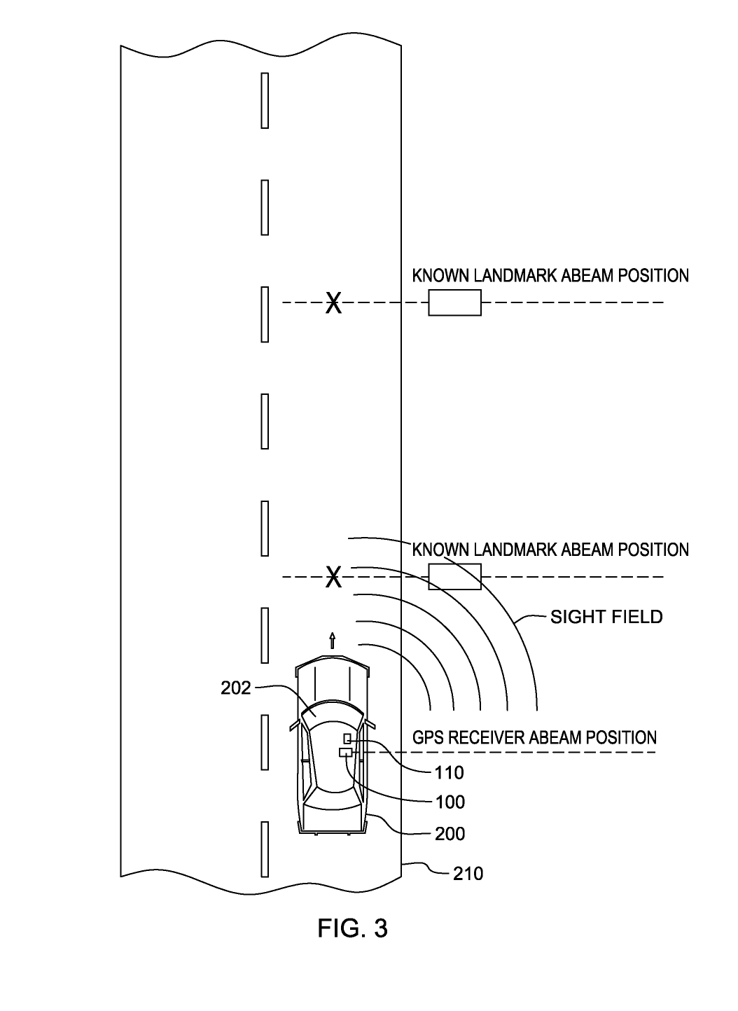

In an example, as depicted in FIG. 3, the camera 110 is mounted facing the right (passenger) side of the road 210, when a vehicle 200 is traveling forward. The camera 110 is integrated into the automobile dash board 202. In other examples, the camera 110 is integrated into the portable GPS receiver 100, such as a rear face of the GPS receiver 100. In these examples, the camera 110 has a fixed field of view and is focused at infinity for reading through a windshield of the vehicle. The camera 110 is side-looking in that within the field of view is an area ninety degrees from the vehicle direction of travel from the long axis of the vehicle. In this arrangement, the field of view is large enough to obtain forward-looking oblique images of landmarks. Additionally, the arrangement allows for the camera 110 to record road signs ranging in height from mile-marker signs to highway exit signs, etc. Furthermore, the side-looking arrangement of the camera 110 allows an exact abeam position of the vehicle relative to the landmarks.

However, in an alternate embodiment the camera is positioned at other locations on the vehicle, such as a hood of the vehicle. In other examples, the camera is positioned in any orientation that allows the system to determine through software an abeam position of the vehicle. In some examples, an existing camera associated with the vehicle, such as a backup camera is used in place of a stand-along camera.

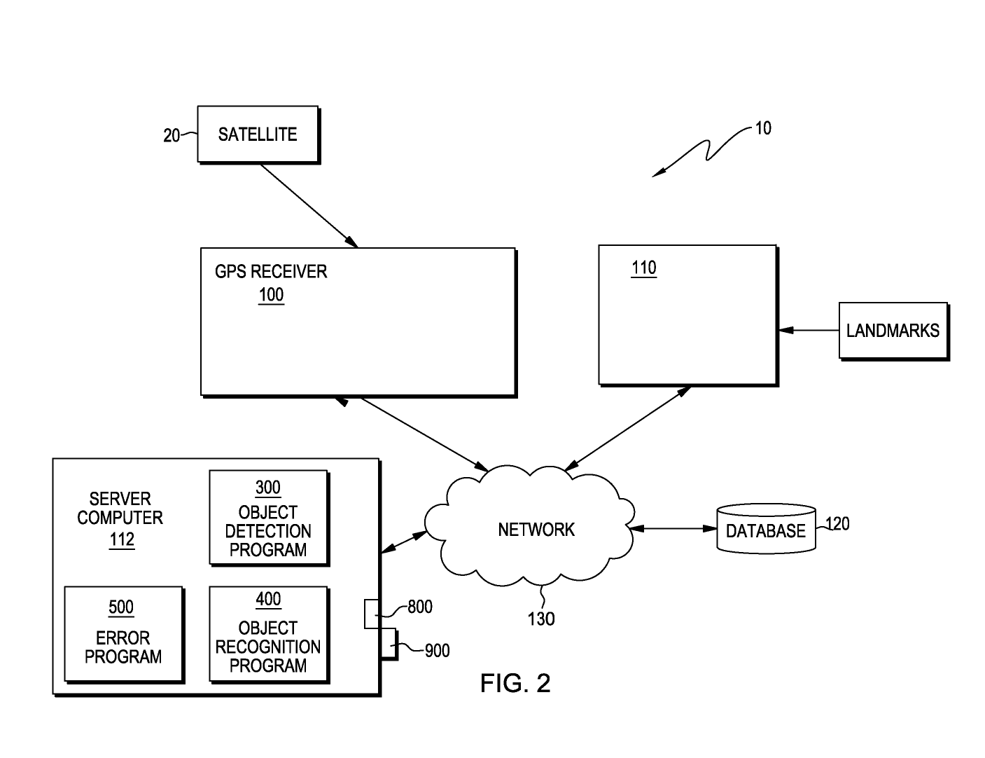

In an alternate embodiment, as illustrated in FIG. 2, the system 10 includes a GPS receiver 100 that receives positioning signals from one or more satellites 20. The GPS receiver 100 is connected with a camera 110, a database 120 of known landmarks, and a computer 112 through a network 130. The computer 112 includes an object detection program 300 that determines if artifacts are detected in obtained image data. The computer 112 includes an object recognition program 400 that determines if artifacts are landmarks in known positions. The computer 112 includes an error program 500, which determines if an approximate position of the GPS receiver 100 at a specified time that is more precise than a position estimated from standard GPS signals

The system 10 includes a GPS receiver 100 that receives positioning signals from one or more satellites 20. The GPS receiver 100 calculates a GPS location (GPS latitude and longitude) by processing the acquired GPS signals. Any number of known GPS receivers 100, such as a portable moving map unit powered by vehicle's auxiliarly power supply, in-dash vehicle multi-function displays with GPS mapping functions, or hand held GPS units may be used to implement examples of the system.

The system 10 includes a camera 110, such as a charge-coupled device (CCD) that is connected with the GPS receiver 100 through a network 130. In examples, the CCD is typically less expensive than known DGPS or WASS. An example of CCD imager that may be used in an exemplary system is a TI TC246 VGA resolution color CCD fabricated by Texas Instruments. In some examples, CCD are accommodated and are mounted within a system enclosure on existing circuit cards (not shown). In an alternate embodiment, the CCD are accommodated and mounted remotely for video capture. In some examples, more than one CCD is mounted and the multiple video imagery is assimilated by video microprocessor 112, as depicted in FIG. 1. In this example, the CCD image processing may be remote by a dedicated microprocessor, or may be remotely processed by a diagnostic computer server.

In some other examples of cameras, the use of infrared and other thermal imaging may be useful for night time operation of the system in identifying landmarks, such as bridges, intersections, traffic lights, buildings, etc. that give off light or a heat signature.

Examples of the system 10 include a database 120 of known landmarks. In some examples, the database 120 may include, but is not limited to, the following information for each stored landmark: text description, a coded identification number, the longitude and latitude position, the orthogonal distance to the nearby roadway, and object recognition indicators. Some examples of object recognition indicators may include, but are not limited to: text, graphical template definitions, edge matching vectors, template matching, gradient histograms, intraclass transfer learning, explicit and implicit 3D object models, global scene representations, shading, reflectance, texture, grammars, topic models, biologically inspired object recognition, window-based detection, 3D cues, context, leveraging internet data, unsupervised learning, fast indexing, etc.

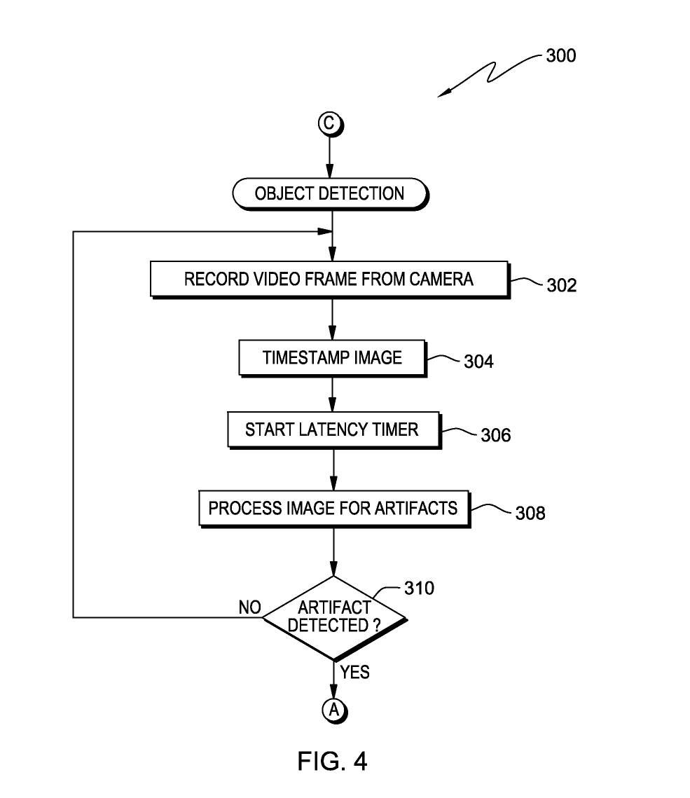

Object recognition techniques currently known in the art are used for identifying features of interest in the video frames. This may include templates, character recognition, edge matching, etc. from the basic identification of the road side features, the following steps are used to convert the raw video image into a longitudinal/latitudinal coordinate of the current vehicle position. FIG. 4 is a flow chart of the object detection program 300 that determines if artifacts are detected in obtained image data. In step 302, the object detection program 300 receives a recorded video frame from the camera. The recording function can be any number of prior art recording functions. In step 304, the object detection program 300 applies a time stamp to the obtained image data. In step 306, the object detection program 300 initiates a latency timer in correlation with the time stamp of the obtained image data. In step 308, object detection program 300 processes the obtained image data for artifacts. Some examples of processing techniques the computer may be, but are not limited to: character recognition, template matching, edge detection, etc. In step 310, the object detection program 300 processes the obtained image data to determine if one or more artifacts are detected. In step 310, if an artifact is not detected, object detection program 300 loops back to step 302 of receiving a recorded video frame from the camera and continues through the normal process flow. In step 310, if an artifact is detected, the object detection program 300 proceeds to the object recognition program 400.

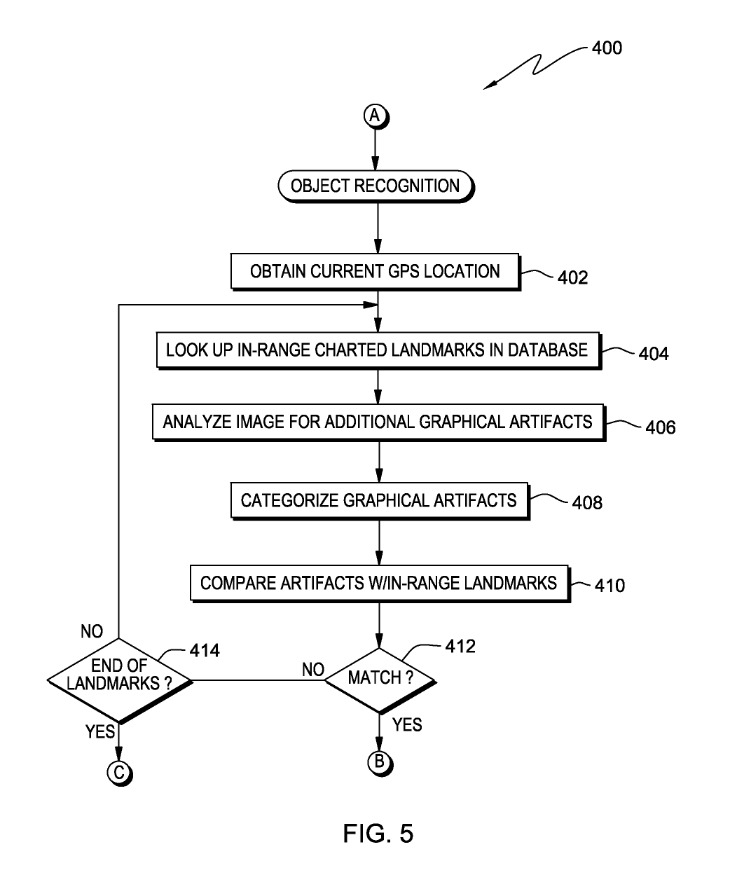

FIG. 5 is a flow chart of the object recognition program 400 that determines if artifacts are landmarks in known positions. In step 402, the object recognition program 400 receives and processes positioning signals from one or more satellites through the GPS receiver to produce an estimated position of the GPS receiver. In this way the video image processing is augmented by the current GPS position to know a general area where the GPS receiver is located. The GPS location proximity is used as a pointer into the landmark database 120 to search for possible nearby landmarks. In step 404, the object recognition program 400 looks up in-range charted landmarks located in the database 120 of known landmarks. In step 406, the object recognition program 400 analyzes the obtained image data for additional graphical artifacts. In step 408, the object recognition program 400 categorizes the graphical artifacts. In step 410, the object recognition program compares the artifacts with the characteristics of the in-range charted landmarks located in the database 120 of known landmarks. In some examples a video image oblique view may be used to determine early identity of landmark objects to compare with the database of landmarks.

In step 412, the object recognition program 400 determines if there is a match between the artifacts with the characteristics of the in-range charted landmarks located in the database 120 of known landmarks. In step 412, if there are not matches, the object recognition program 400 determines if there are any additional landmarks, found in step 414. In step 412, if there are matches, the object recognition program 400 proceeds to the error program 500. In step 414, if there are more additional landmarks, the object recognition program loops back to step 404 of looking up in-range charted landmarks located in the database 120 of known landmarks. In step 414, if there are not any more additional landmarks, the object recognition program 400 loops back to step 302 at the start of the object detection program. Therefore, the object recognition program 400 compares the obtained image data of the landmarks with a database of known landmarks situated near the estimated position of the GPS receiver to determine positions of the one or more known landmarks surrounding the estimated position of the GPS receiver.

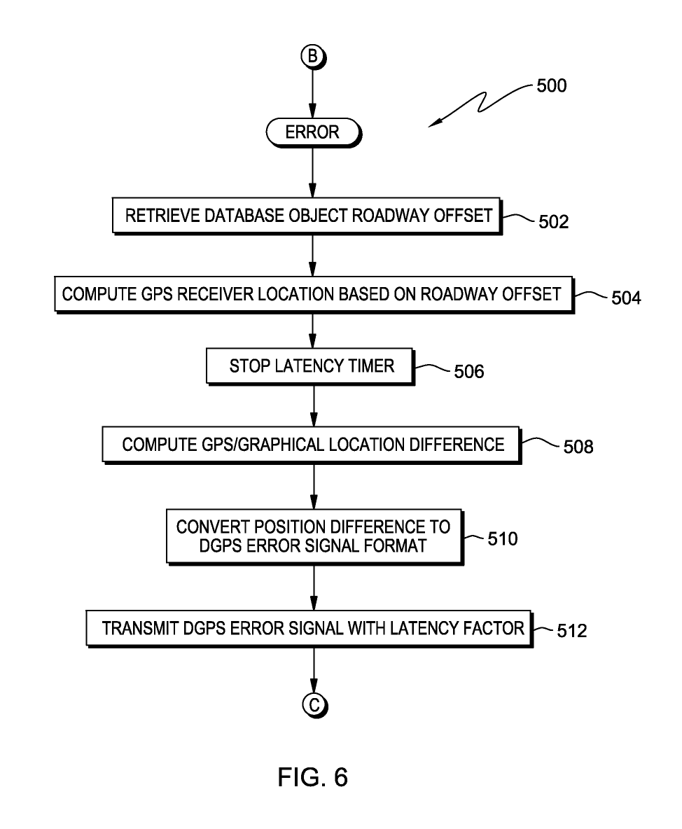

FIG. 6 is a flow chart of the error program 500, which determines an approximate position of the GPS receiver 100 at a specified time that is more precise than a position estimated from standard GPS signals. The error program 500 determines the vehicle position by utilizing image data captured using the camera, which is independent of utilizing a GPS signal. Effectively, the error program 500 employs the use of more accurate, but less frequent landmarks to generate the DGPS error signal. In step 502, the error program 500 retrieves positions of the one or more known landmarks offset of the roadway from the database 120 of known landmarks. The error program 500 may estimate the offset by assuming the GPS receiver will be in a predetermined location of the roadway to make calculations. In some examples, the error program may determine from the video image which lane of a multi-lane road the vehicle is traveling on. In step 504, the error program 500 determines the GPS receiver location, and therefore the corresponding vehicle location based on the roadway offset. For increased accuracy, the abeam vehicle position directly beside the landmark may be determined. In step 506, the error program 500 ends the latency timer. In step 508, the error program 500 determines the position difference between the GPS position obtained using the positioning signals of the GPS receiver 100 and the position of GPS receiver determined by comparing the graphical location of known landmarks from the obtained image data of landmarks. In step 510, the error program 500 converts the position difference to a DGPS error signal format using an emulation program. In the emulation program, the typical GPS receiver is designed to receive an error signal, such as an error signal provided by a ground based differential GPS (DGPS) tower. Examples of the system provide a compatible error signal to DGPS which is an output signal derived by the system. In examples, the video processing microcontroller output port and wiring is compatible with known GPS receiver DGPS input ports. The DGPS error signal may be in a data format for DGPS signaling expected by the automobile DGPS enabled dataport. In step 512, the error program 500 transmits the DGPS error signal plus a latency factor. The latency factor is the processing time from the point where photo image data is recorded to the point in time when the DGPS error signal is available. This is a common process in using DGPS signaling. Known methods in the art may be used to factor in the latency of the derived DGPS error signal when used by the GPS receiver. In some examples, the computer receives the DGPS signal in real time as new position errors are calculated by known landmarks in the landmark database.

In the known art, a latency signal is used in standard DGPS to consider the RF transmit time of the DGPS signal to the GPS Receiver and movement of GPS Receiver. In some examples, the system uses this latency signal to also include the graphical landmark identification processing latency so it too can be factored out when the standard GPS/DGPS processing occurs inside a GPS receiver using exemplary embodiments of the method.

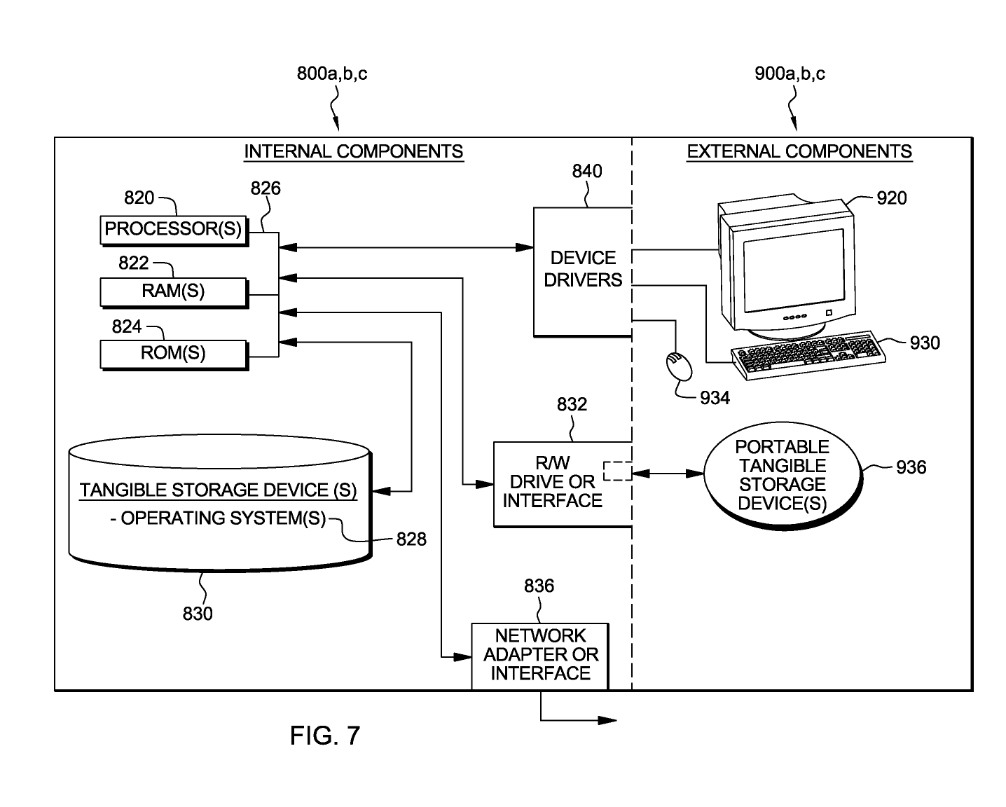

Computers 102 and 112 include respective sets of internal components 800a,b,c and external components 900a,b,c, illustrated in FIG. 7. Each of the sets of internal components 800a,b,c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs 300, 400 and 500 (for computer 102) are stored on one or more of the respective computer-readable tangible storage devices 830 for execution by one or more of the respective processors 820 via one or more of the respective RAMs 822 (which typically include cache memory). In the illustrated embodiment, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information. In an alternate embodiment, the one or more operating systems 828 and programs 300 (for computer 112), and 400 and 500 (for computer 102) are stored on one or more of the respective computer-readable tangible storage devices 830 for execution by one or more of the respective processors 820 via one or more of the respective RAMs 822 (which typically include cache memory).

Each set of internal components 800a,b,c also includes a R/W drive or interface 832 to read from and write to one or more portable computer-readable tangible storage devices 936 such as a CD-ROM, DVD, memory stick, magnetic tape, magnetic disk, optical disk or semiconductor storage device. The programs 300, 400 and 500 (for computer 102) can be stored on one or more of the respective portable computer-readable tangible storage devices 936, read via the respective R/W drive or interface 832 and loaded into the respective hard drive 830.

Each set of internal components 800a,b,c also includes a network adapter or interface 836 such as a TCP/IP adapter card. The programs 300, 400 and 500 (for computer 102) can be downloaded to the respective computers from an external computer or external storage device via a network (for example, the Internet, a local area network or other, wide area network) and network adapter or interface 836. From the network adapter or interface 836, the programs are loaded into the respective hard drive 830. The network may comprise copper wires, optical fibers, wireless transmission, routers, firewalls, switches, gateway computers and/or edge servers.

Each of the sets of external components 900a,b,c includes a computer display monitor 920, a keyboard 930, and a computer mouse 934. Each of the sets of internal components 800a,b,c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The programs can be written in various programming languages (such as Java, C++) including low-level, high-level, object-oriented or non object-oriented languages. Alternatively, the functions of the programs can be implemented in whole or in part by computer circuits and other hardware (not shown).

Based on the foregoing, a computer system, method and program product have been disclosed for determining an approximate position of a global positioning system (GPS) receiver of a global positioning receiver connected to a computer. However, numerous modifications and substitutions can be made without deviating from the scope of the present invention. Therefore, the present invention has been disclosed by way of example and not limitation.

What is claimed is:

1. A method for determining an approximate position of a global positioning system (GPS) receiver of a global positioning receiver connected to a computer, the method comprising the steps of:
a computer obtaining image data surrounding the GPS receiver through a camera associated with the GPS receiver and operably coupled to the computer;
the computer applying a time stamp to the obtained image data;
the computer initiating a latency timer;
the computer processing the obtained image data to determine if one or more artifacts are detected;
a computer receiving positioning signals from one or more satellites through the GPS receiver;
the computer processing the positioning signals to produce an estimated position of the GPS receiver;
the computer comparing the obtained image data of the landmarks with a database of known landmarks situated near the estimated position of the GPS receiver to determine positions of the one or more known landmarks surrounding the estimated position of the GPS receiver; and
the computer determining an approximate position of the GPS receiver at a specified time correlated from applied time stamp of obtained image data that is more precise than the estimated position, based on determined positions of the one or more known landmarks relative to the GPS receiver and known locations of the plurality of the known landmarks.

2. The method of claim 1, wherein the step of the computer determining the approximate position of the GPS receiver comprises:
the computer receiving positions of the one or more of known landmarks offset of the roadway from the database;
the computer determining the position of the GPS receiver;
the computer ending the latency timer;
the computer determining a position difference by comparing the position of the landmark and the position of the GPS receiver;
the computer converting the position difference to a DPGS error signal format; and
the computer transmitting the DPGS error signal with a latency factor.

3. The method of claim 1, further comprising the step of:
the computer establishing a connection with the satellite while the global positioning device is within a range of the satellite.

4. The method of claim 2, further comprising the step of:
the computer converts the error position into the data format for DGPS signaling expected by a DGPS enabled dataport.

5. The method of claim 4, further comprising the step of:
the computer receives the DGPS signal in real time as new position errors are calculated by known landmarks in the database.

6. The method of claim 1, further comprising the step of:
the computer determining landmarks moving towards the camera by comparing the database of known landmarks with image data obtained in an oblique view produced by the camera.

7. The method of claim 1, further comprising the step of:
the computer determining the lane of a multi-lane road the GPS receiver is traveling.

8. The method of claim 1, wherein the computer determines the position of the GPS receiver wherein the estimated position of the GPS receiver is approximately orthogonal from a forward-projecting face of the GPS receiver.

9. A computer program product for determining an approximate position of a global positioning system (GPS) receiver of a global positioning receiver connected to a computer, the computer program product comprising:
one or more computer-readable, tangible storage devices and program instructions stored on at least one of the one or more storage devices, the program instructions comprising;
program instructions to obtain image data surrounding the GPS receiver through a camera associated with the GPS receiver and operably coupled to the computer;
program instructions to apply a time stamp to the obtained image data;
program instructions to initiate a latency timer;
program instructions to process the obtained image data to determine if one or more artifacts are detected;
program instructions to receive positioning signals from one or more satellites through the GPS receiver;
program instructions to process the positioning signals to produce an estimated position of the GPS receiver;
program instructions to compare the obtained image data of the landmarks with a database of known landmarks situated near the estimated position of the GPS receiver to determine positions of the one or more known landmarks surrounding the estimated position of the GPS receiver; and
program instructions to determine an approximate position of the GPS receiver at a specified time correlated from applied time stamp of obtained image data that is more precise than the estimated position, based on determined positions of the one or more known landmarks relative to the GPS receiver and known locations of the plurality of the known landmarks.

10. The computer program product of claim 9, wherein the step of the program instructions to determine the approximate position of the GPS receiver comprises:
program instructions to receive positions of the one or more of known landmarks offset of the roadway from the database;
program instructions to determine the position of the GPS receiver;
program instructions to end the latency timer;
program instructions to determine a position difference by comparing the position of the landmark and the position of the GPS receiver;
program instructions to convert the position difference to a DPGS error signal format; and
program instructions to transmit the DPGS error signal with a latency factor.

11. The computer program product of claim 10, further comprising:
program instructions to convert the error position into the data format for DGPS signaling expected by a DGPS enabled dataport.

12. The computer program product of claim 11, further comprising:
program instructions to receive the DGPS signal in real time as new position errors are calculated by known landmarks in the database.

13. The computer program product of claim 9, further comprising:
program instructions to determine landmarks moving towards the camera by comparing the database of known landmarks with image data obtained in an oblique view produced by the camera.

14. The computer program product of claim 9, further comprising:
program instructions to determine the lane of a multi-lane road the GPS receiver is traveling.

15. A computer system for determining an approximate position of a global positioning system (GPS) receiver of a global positioning receiver connected to a computer, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to obtain image data surrounding the GPS receiver through a camera associated with the GPS receiver and operably coupled to the computer;
program instructions, stored on at least one of the one or more storage devices for execution by at least one of the one or more processors via at least one of the one or more memories, to apply a time stamp to the obtained image data;
program instructions, stored on at least one of the one or more storage devices for execution by at least one of the one or more processors via at least one of the one or more memories, to initiate a latency timer;
program instructions, stored on at least one of the one or more storage devices for execution by at least one of the one or more processors via at least one of the one or more memories, to process the obtained image data to determine if one or more artifacts are detected;
program instructions, stored on at least one of the one or more storage devices for execution by at least one of the one or more processors via at least one of the one or more memories, to receive positioning signals from one or more satellites through the GPS receiver;
program instructions, stored on at least one of the one or more storage devices for execution by at least one of the one or more processors via at least one of the one or more memories, to process the positioning signals to produce an estimated position of the GPS receiver;
program instructions, stored on at least one of the one or more storage devices for execution by at least one of the one or more processors via at least one of the one or more memories, to compare the obtained image data of the landmarks with a database of known landmarks situated near the estimated position of the GPS receiver to determine positions of the one or more known landmarks surrounding the estimated position of the GPS receiver; and
program instructions, stored on at least one of the one or more storage devices for execution by at least one of the one or more processors via at least one of the one or more memories, to determine an approximate position of the GPS receiver at a specified time correlated from applied time stamp of obtained image data that is more precise than the estimated position, based on determined positions of the one or more known landmarks relative to the GPS receiver and known locations of the plurality of the known landmarks.

16. The computer system of claim 15, wherein the step of the program instructions to determine the approximate position of the GPS receiver comprises:
program instructions, stored on at least one of the one or more storage devices for execution by at least one of the one or more processors via at least one of the one or more memories, to receive positions of the one or more of known landmarks offset of the roadway from the database;
program instructions, stored on at least one of the one or more storage devices for execution by at least one of the one or more processors via at least one of the one or more memories, to determine the position of the GPS receiver;
program instructions, stored on at least one of the one or more storage devices for execution by at least one of the one or more processors via at least one of the one or more memories, to end the latency timer;
program instructions, stored on at least one of the one or more storage devices for execution by at least one of the one or more processors via at least one of the one or more memories, to determine a position difference by comparing the position of the landmark and the position of the GPS receiver;
program instructions, stored on at least one of the one or more storage devices for execution by at least one of the one or more processors via at least one of the one or more memories, to convert the position difference to a DPGS error signal format; and
program instructions, stored on at least one of the one or more storage devices for execution by at least one of the one or more processors via at least one of the one or more memories, to transmit the DPGS error signal with a latency factor.

17. The computer program product of claim 16, further comprising:
program instructions, stored on at least one of the one or more storage devices for execution by at least one of the one or more processors via at least one of the one or more memories, to convert the error position into the data format for DGPS signaling expected by a DGPS enabled dataport.

18. The computer program product of claim 17, further comprising:
program instructions, stored on at least one of the one or more storage devices for execution by at least one of the one or more processors via at least one of the one or more memories, to receive the DGPS signal in real time as new position errors are calculated by known landmarks in the database.

19. The computer program product of claim 15, further comprising:
program instructions, stored on at least one of the one or more storage devices for execution by at least one of the one or more processors via at least one of the one or more memories, to determine landmarks moving towards the camera by comparing the database of known landmarks with image data obtained in an oblique view produced by the camera.

20. The computer program product of claim 15, further comprising:
program instructions, stored on at least one of the one or more storage devices for execution by at least one of the one or more processors via at least one of the one or more memories, to determine the lane of a multi-lane road the GPS receiver is traveling.
